(19) United States
(12) Patent Application Publication
(10) Pub. No.: US 2026/0101172 A1
(43) Pub. Date: Apr. 9, 2026

(54) UPDATING USER EQUIPMENT WITH SUSPENDED SUBSCRIBER IDENTITY MODULE

(71) Applicant: T-Mobile USA, Inc., Bellevue, WA (US)

(72) Inventor: Christopher Bailey, Overland Park, KS (US)

(73) Assignee: T-Mobile USA, Inc., Bellevue, WA (US)

(21) Appl. No.: 18/910,851

(22) Filed: Oct. 9, 2024

(51) Int. Cl. H04W 8/18

(52) U.S. Cl. CPC H04W 8/18

(57) ABSTRACT

Techniques for configuring user equipment that has been suspended or deactivated are discussed herein. In some examples, the techniques can include remotely configuring the user equipment (UE) in response to the UE attempting to access a network while the UE includes a subscriber identity module (SIM) that is suspended or deactivated. When a suspended UE attempts to access a network, a message may be routed to a network node, which can respond (or cause the network to respond) with a cause code or a device profile. In some examples, the UE may activate a device profile stored in the device based on the cause code or the UE can configure itself based on the received device profile. In this manner, a suspended device can be prevented from accessing a network but may remain functional for many other uses as well as for emergency communications.

### BACKGROUND

Cellular communication devices use network radio access technologies to communicate wirelessly with geographically distributed cellular base stations. Long-Term Evolution (LTE) is an example of a widely implemented radio access technology that is used in 4^{th} Generation (4G) communication systems. New Radio (NR) is a newer radio access technology that is used in 5^{th} Generation (Fifth Generation, or 5G) communication systems. Standards for LTE and NR radio access technologies have been developed by the 3rd Generation Partnership Project (3GPP) for use by wireless communication carriers.

Cellular communication devices may remain active even if an account associated with a device is suspended or deactivated. For example, all cellular devices may call emergency numbers, such as 911. However, when a cellular communication device is suspended or deactivated the device may still access the network for non-emergency calls, which may become a drain on network resources. In some examples, network access for a suspended or deactivated device may be temporarily disabled, but network access may be available after a period of time has passed.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment including a suspended user equipment accessing a network and receiving a cause code or device profile to disable network access, in accordance with aspects of the disclosure.

FIG. 2 depicts a sequence diagram of example operations and messages for handling a deactivated user equipment with a subscriber identity module (SIM) still in place, in accordance with aspects of the disclosure.

FIG. 3 illustrates an example process for configuring a user equipment based on a cause code or device profile, in accordance with aspects of the disclosure.

FIG. 4 illustrates an example computing device configured to update a configuration based on the computing device accessing a network with a suspended or deactivated status, in accordance with aspects of the disclosure.

FIG. 5 illustrates another example process for configuring a user equipment based on a cause code or device profile, in accordance with aspects of the disclosure.

### DETAILED DESCRIPTION

Described herein are techniques for configuring a user equipment that has been suspended or deactivated. In some examples, the techniques can include remotely configuring the user equipment (UE) in response to the UE accessing or attempting to access a network while the UE includes a subscriber identity module (SIM) that is suspended or deactivated. For example, a UE for a user may be suspended or deactivated but the user may not have removed or transferred the SIM to another device. The UE may attempt to connect to a network for a variety of reasons (e.g., to browse the internet, to make a (non-emergency) phone call, etc.). But, when the UE attempts to access a network, a message may be routed to a network node, such as a home subscriber server (HSS) or unified data management (UDM). The network node can respond with a cause code or a device profile. The UE can receive data from the network in response to attempting to attach to the network. In the case of receiving a cause code, the UE may activate a device profile stored in the device (e.g., pre-stored in memory of the UE) based on the cause code, and in the case of receiving a device profile, the device can configure itself based on the received device profile. The updated configuration can include, but is not limited to, deactivating cellular radio(s) on the UE, activating Wi-Fi or alternate communication band(s), updating a list of available networks, restricting access to network node(s), presenting indications via the UE (e.g., on a display), and the like. In this manner, a suspended device can be prevented from accessing a network but may remain functional for many other uses, and emergency access can remain unchanged.

In some examples, a UE that is no longer provisioned on a provider's network may be referred to as a suspended UE or deactivated UE. In some examples, such suspended or deactivated UEs may continue to attempt to connect to the network. Network traffic associated with these network connection attempts can slowly take up network resources that could otherwise be used for active devices. When a suspended or deactivated UE attempts to access a network (e.g., via an eNodeB or a gNodeB), the techniques can include having an MME (mobility management entity) or AMF (access and mobility management function) query the HSS or UDM and first decide if the device is no longer live on the network prior to sending a service reject message. In some examples, and in response to receiving the data from the suspended/deactivated UE, the AMF/MME can first provide a cause code to the suspended/deactivated UE, which can add the network provider's PLMN to a forbidden PLMN list on the suspended/deactivated UE. In some examples, an IMEI/IMSI of the suspended/deactivated UE can be delivered to a configuration server where a profile payload becomes available (over Wi-Fi or cellular radio) which can disable voice and/or data services over cellular radio. In some examples, this can include updating a list of accessible networks (e.g., by removing entries, such as a public land mobile network (PLMN), a Home PLMN (HPLMN), an Equivalent Home PLMN (eHPLMN), an Operator PLMN (OPLMN) (e.g., stored on the UE)) and/or disabling the cellular radio of the suspended/deactivated UE.

In some examples, the techniques may not effect call handling for emergency call(s) such that UEs may still access network resources for an emergency call. Further, in some examples, when UE does place an emergency call, the cellular radio(s) can remain active for a period of time to ensure that regulatory requirements can be fulfilled. In some examples, a cellular radio of a UE configured in accordance with the cause code and/or device profile would remain off until the emergency number is dialed, and the radio would then be disabled after a given amount of time to ensure that regulatory emergency call requirements are fulfilled. In some examples, the suspended/deactivated profile of the UE can be reset if the SIM is replaced with a new SIM, if the current SIM is removed and replace, or if network services are reset on the device or network and the UE receives data to reactivate the cellular radio(s). Additional details are discussed throughout this disclosure.

The systems, devices, and techniques described herein can improve the functioning of a device (e.g., a user equipment) by configuring the UE when the device (or an account associated with the device) is suspended or deactivated. For example, conventional suspended devices can access a network and the network may reject such access attempts. The UE can try a next resource and may continue to access the network(s) through various means, which may create additional signaling in the network and/or can drain a battery of the UE. In some examples, conventional techniques may temporarily suspend the UE from accessing a particular PLMN for a particular period of time (e.g., 24 hours), although the device may continue to access the network after expiration of the time period. Thus, conventional techniques fail to properly configure a suspended/deactivated device. Further, configuring a suspended/deactivated device in this matter may allow a user to use the device for a number of purposes, such as listening to music, accessing the internet via Wi-Fi, sending/receiving data with peripheral devices such as a smartwatch or other wearables, and the like. Configuring the device in this manner may preserve battery power by disabling cellular radio(s) and/or by preventing non-emergency cellular network access and associated signaling. Additionally, the techniques discussed herein may not affect emergency services despite the device being suspended or deactivated. The techniques may further improve a functioning of a network by reducing initiation of communications where a device is suspended and preventing suspended UE(s) from accessing such cellular resources, which may reduce signaling and associated congestion. These and other improvements to the functioning of a computer and network are discussed herein.

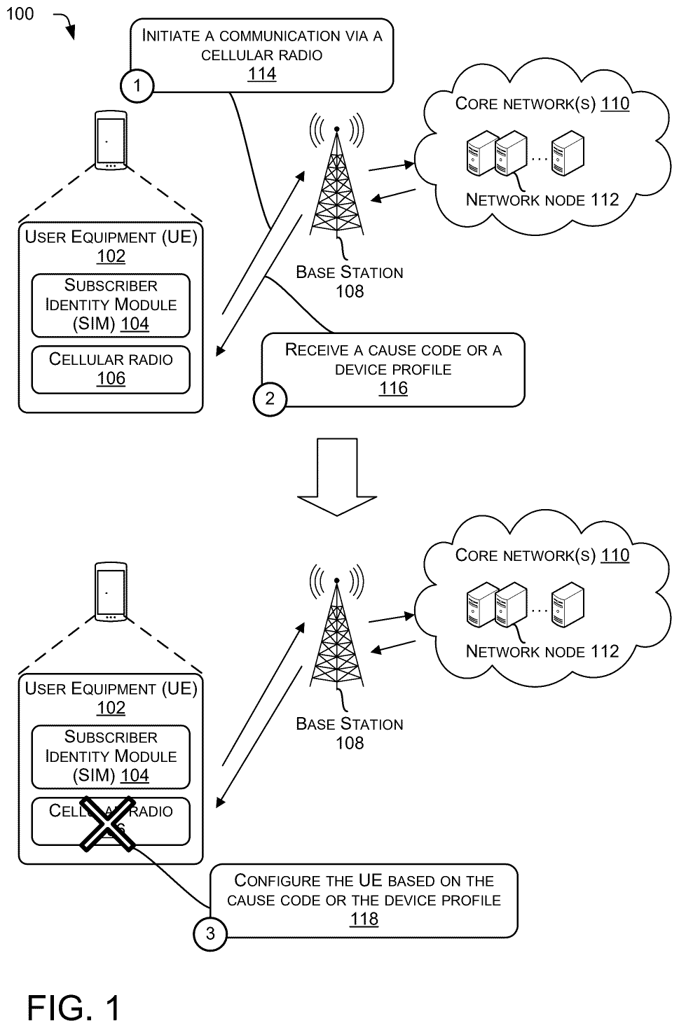

FIG. 1 illustrates an example environment 100 including a suspended user equipment accessing a network and receiving a cause code or device profile to disable network access, in accordance with aspects of the disclosure.

The environment 100 includes a user equipment 102 comprising a subscriber identity module (SIM) 104 and a cellular radio 106. The environment 100 also includes a base station 108 and core network(s) 110 comprising network node(s) 112 (e.g., one or more core network nodes).

The environment 100 also illustrates various operations in accordance with the techniques discussed herein. For example, at a first time, and as illustrated as operation 114, the UE 102 can initiate a communication via a cellular radio. In this example, the UE 102 is suspended or disabled but still includes the SIM 104. The operation 114 can include the UE 102 establishing a communication with the base station 108, which may send data to the network node(s) 112 in the core network(s) 110.

At a second time after the first time, and as illustrated as operation 116, the network node(s) 112 can send data via the base station 108 to the UE 102. In some examples, the operation 116 can include the UE 102 receiving a cause code or a device profile. In some examples, the cause code can indicate to the UE 102 that the SIM 104 associated with the UE 102 is suspended or disabled. In some examples, the device profile received in the operation 118 can include one or more settings, profiles, or configurations that configure the UE 102 according to the device profile.

Although FIG. 1 is described, in some examples, from the perspective of the UE 102, the operations 114 and 118 can also be described from the perspective of the core network(s) 110. For example, the operation 114 can include receiving, at the core network(s) 110, a request from the UE 102 to establish a communication using the cellular radio 106 of the UE 102. In some examples, the operation 118 can include the core network(s) 110 determining that the UE 102 is a suspended or deactivated device and sending one or more of a cause code or device profile to the UE 102 via the base station 108.

Further, in some examples, the UE 102 may access the core network(s) 110 via a Wi-Fi access point (e.g., when initiating a Wi-Fi call). In such examples, the core network(s) 110 may still determine that the UE 102 is suspended and the core network(s) 110 can respond with a cause code and/or a device profile.

Next, at a third time after the second time, and as illustrated as operation 118, the UE 102 can configure the UE 102 based on the cause code or the device profile. In some examples, the UE 102 can disable the cellular radio 106 in response to the cause code or the device profile received in the operation 116. In additional or alternative examples, the operation 118 can include enabling Wi-Fi, Bluetooth, Near-field Communication (NFC), and/or other alternative communication band. In some examples, the operation 118 can include updating list of available networks to remove the core network(s) 110 from the available list of networks. In some examples, the operation 118 can include removing one or more HPLMN (home public land mobile network)/eHPLMN (Equivalent Home PLMN)/OPLMN (Operator PLMN) entries (e.g., stored in memory (e.g., a non-volatile memory) of the UE 102). Additional details of configuring the UE 102 in response to a cause code and/or a device profile are discussed throughout this disclosure.

In some examples, the UE 102 can comprise any of various types of wireless cellular communication devices that are capable of wireless data and/or voice communications, including smartphones and other mobile devices, “Internet-of-Things” (IoT) devices, smart home devices, computers, wearable devices, entertainment devices, industrial control equipment, etc. Further examples can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a network. Additional examples of UEs include, but are not limited to, smart devices such as televisions, refrigerators, washing machines, dryers, smart mirrors, coffee machines, lights, lamps, temperature sensors, leak sensors, water sensors, electricity meters, parking sensors, music players, headphones, or any other electronic appliances that can generate, request, receive, transmit, or exchange voice, video, and/or digital data over a network.

In general, the UE 102 can include any device that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), VoLTE, Institute of Electrical and Electronics Engineers' (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology. The UE 102 can implement enhanced Mobile Broadband (eMBB) communications, Ultra Reliable Low Latency Communications (URLLCs), massive Machine Type Communications (mMTCs), and the like. In some examples, the UE 102 can communicate via any terrestrial (e.g., ground-based) and/or non-terrestrial (e.g., satellite) base stations.

In some examples, the base station 108 can comprise one or more of an eNodeB (eNB), a gNodeB (gNB), and the like. In some examples, the base station 108 can be any device that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), VoLTE, Institute of Electrical and Electronics Engineers' (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology. The base station 108 can implement enhanced Mobile Broadband (eMBB) communications, Ultra Reliable Low Latency Communications (URLLCs), massive Machine Type Communications (mMTCs), and the like. In some examples, the base station 108 can be any terrestrial (e.g., ground-based) and/or non-terrestrial (e.g., satellite) base station.

In some examples, the base station 108 can utilize a 4G radio technology. The base station 108 may transmit and receive data via a connection (e.g., at least one LTE radio link) that is defined according to frequency bands included in, but not limited to, a range of 450 MHz to 5.9 GHz. In some instances, the frequency bands utilized for the base station 108 can include, but are not limited to, LTE Band 1 (e.g., 2100 MHz), LTE Band 2 (1900 MHz), LTE Band 3 (1800 MHz), LTE Band 4 (1700 MHz), LTE Band 5 (850 MHz), LTE Band 7 (2600 MHz), LTE Band 8 (900 MHz), LTE Band 20 (800 MHz GHz), LTE Band 28 (700 MHz), LTE Band 38 (2600 MHz), LTE Band 41 (2500 MHz), LTE band 48 (e.g., 3500 MHz (the CBRS band)), LTE Band 50 (1500 MHz), LTE Band 51 (1500 MHz), LTE Band 66 (1700 MHz), LTE Band 70 (2000 MHz), LTE Band 71 (e.g., a 600 MHz band), LTE Band 74 (1500 MHz), and the like. In some examples, the base station 108 can be, or at least include, an eNodeB.

In some instances, the base station 108 can also utilize a 5G radio technology, such as technology specified in the 5G NR standard, as defined by 3GPP. In certain implementations, the base station 108 can transmit and receive communications with devices over a connection (e.g., at least one NR radio link) that is defined according to frequency resources including but not limited to 5G Band 1 (e.g., 2080 MHz), 5G Band 2 (1900 MHz), 5G Band 3 (1800 MHz), 5G Band 4 (1700 MHz), 5G Band 5 (850 MHz), 5G Band 7 (2600 MHz), 5G Band 8 (900 MHz), 5G Band 20 (800 MHz), 5G Band 28 (700 MHz), 5G Band 38 (2600 MHz), 5G Band 41 (2500 MHz), NR Band 48 (e.g., 3500 MHz (the CBRS band)), 5G Band 50 (1500 MHz), 5G Band 51 (1500 MHz), 5G Band 66 (1700 MHz), 5G Band 70 (2000 MHz), 5G Band 71 (e.g., a 600 MHz band), 5G Band 74 (1500 MHz), 5G Band 257 (28 GHz), 5G Band 258 (24 GHz), 5G Band 260 (39 GHz), 5G Band 261 (28 GHz), and the like. In some examples, the base station 108 can be, or at least include, a gNodeB.

FIG. 1 also shows a single UE 102 (also referred to as a cellular communication device 102 or a device 102), which may be one of many such devices that are configured for use with the techniques discussed herein. In the described example, the UE 102 supports both 4G/LTE and 5G/NR networks and communications. Further, in the described examples, the UE 102 supports both terrestrial networks and non-terrestrial networks.

In some examples, the core network(s) 110 can include a 4G core network and/or a 5G core network.

In some examples, the core network 110 can include (e.g., as the network node 112) 4G core network comprising a Mobility Management Entity (MME), a Serving Gateway (SGW), a Packet Data Network (PDN) Gateway (PGW), a Home Subscriber Server (HSS), an Access Network Discovery and Selection Function (ANDSF), an evolved Packet Data Gateway (ePDG), and the like.

In some examples, the core network 110 can include (e.g., as the network node 112) a 5G core network comprising any of an Access and Mobility Management Function (AMF), a Session Management Function (SMF), a Policy Control Function (PCF), an Application Function (AF), an Authentication Server Function (AUSF), a Network Slice Selection Function (NSSF), a Unified Data Management (UDM), a Network Exposure Function (NEF), a Network Repository Function (NRF), a User Plane Function (UPF), and the like.

In some examples, the core networks(s) 110 can be communicatively coupled with an open network, such as the internet.

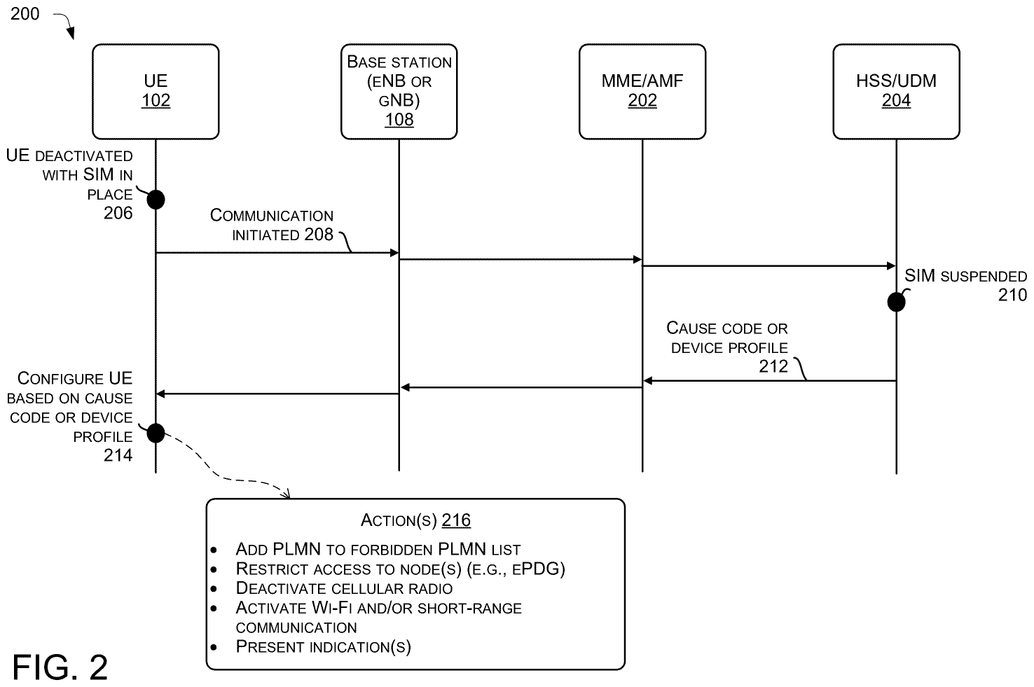

FIG. 2 depicts a sequence diagram 200 of example operations and messages for handling a deactivated user equipment with a subscriber identity module (SIM) still in place, in accordance with aspects of the disclosure.

FIG. 2 illustrates the UE 102 in communication with the base station 108, a first network node 202 (e.g., an MME/AMF), and a second network node 204 (e.g., an HSS/UDM 204).

In a first example where the UE 102 communicates with the base station 108 via 4G protocols, the base station 108 can represent an eNodeB, the network node 202 can represent an MME, and the network node 204 can represent an HSS.

In a second example where the UE 102 communicates with the base station 108 via 5G protocols, the base station 108 can represent a gNodeB, the network node 202 can represent an AMF, and the network node 204 can represent an UDM. Of course, techniques are not limited to the first and second aforementioned examples and various implementations and permutations are contemplated herein.

In this example, the sequence diagram 200 may begin at operation 206 wherein the UE is deactivated with a SIM in place. In some examples, the UE 102 may represent a UE where a user has transferred their service to another UE but left the SIM in place in the UE 102.

Next, at operation 208, the UE 102 can initiate a communication via a cellular radio of the UE 102. In some examples, the operation 208 can include the UE 102 sending one or more messages to the base station 108 to attach and/or initiate a communication at the UE 102. The base station 108 can assign a temporary identifier associated with the communication and/or the UE 102 and can send and/or forward signaling (and/or data or messages) to the MME/AMF 202, which in turn can send and/or forward the signaling (and/or data or messages) to the HSS/UDM 204.

The HSS/UDM 204 can query an internal or remote database and determine that the SIM associated with the UE 102 is suspended (or deactivated) at the operation 210.

In response to determining that the SIM is suspended in the operation 210, the HSS/UDM 204 can send (or cause another network node to send) a cause code or device profile to the UE 102 in operation 212. The cause code and/or device profile sent in the operation 212 can be transmitted via the MME/AMF 202 (or via another route) to the base station 108 and ultimately to the UE 102.

In some examples, the HSS/UDM 204 can send a cause code to the base station 108, where the base station 108 can determine whether the UE 102 is configured to receive a cause code or a device profile, and the base station 108 can send the appropriate response to the UE 102. For example, the base station 108 can request device characteristics or capabilities associated with the UE 102 and can determine whether to send a cause code or device profile to the UE 102. In some examples, the base station 108 can include one or more device profile(s) and can access and send a particular device profile based on the UE 102 characteristics.

At operation 214, the process can include configuring the UE based on the cause code or the device profile.

In some examples, the operation 214 can include performing one or more action(s) 216. In some examples, the action(s) 216 can include one or more of: adding a PLMN to a forbidden PLMN list (e.g., adding and/or removing entries in memory (e.g., non-volatile memory) of the UE 102); restricting access to node(s) (e.g., network node(s) such as ePDG (evolved packet data gateway)); deactivating cellular radio(s) associated with the UE 102; activating Wi-Fi and/or short-range communication(s) (e.g., Bluetooth, NRF, etc.); presenting indication(s) (e.g., causing presentation of message(s) (e.g., via the display and/or speakers) indicating to a user that the UE 102 is suspended/deactivated and that cellular communications are not available for non-emergency calls); and the like.

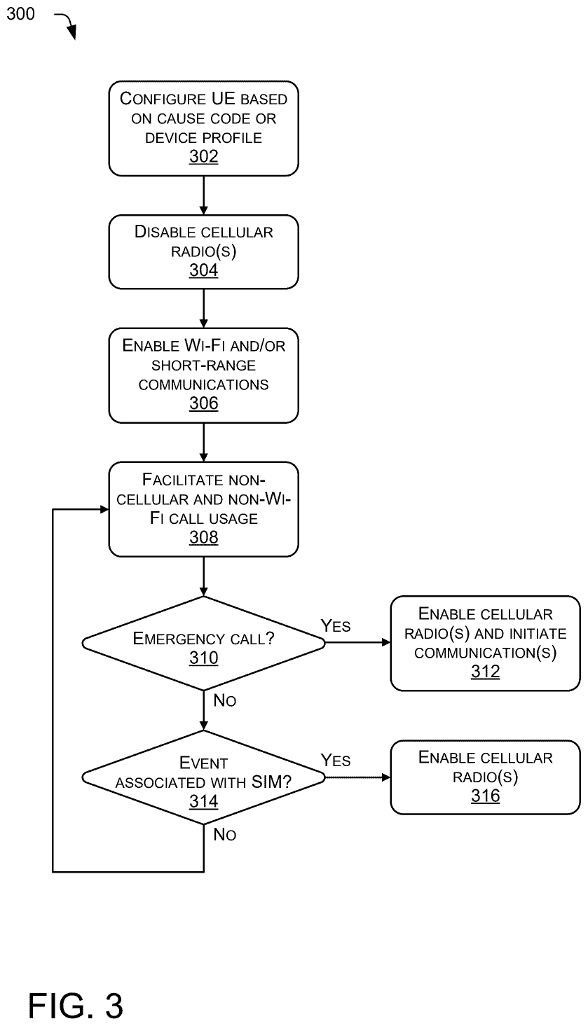

FIG. 3 illustrates an example process 300 for configuring a user equipment based on a cause code or device profile, in accordance with aspects of the disclosure. The example process 300 can be performed by the UE 102 (and/or another component), in connection with other components and/or devices discussed herein. Some or all of the process 300 can be performed by one or more devices or components in the environment 100, for example.

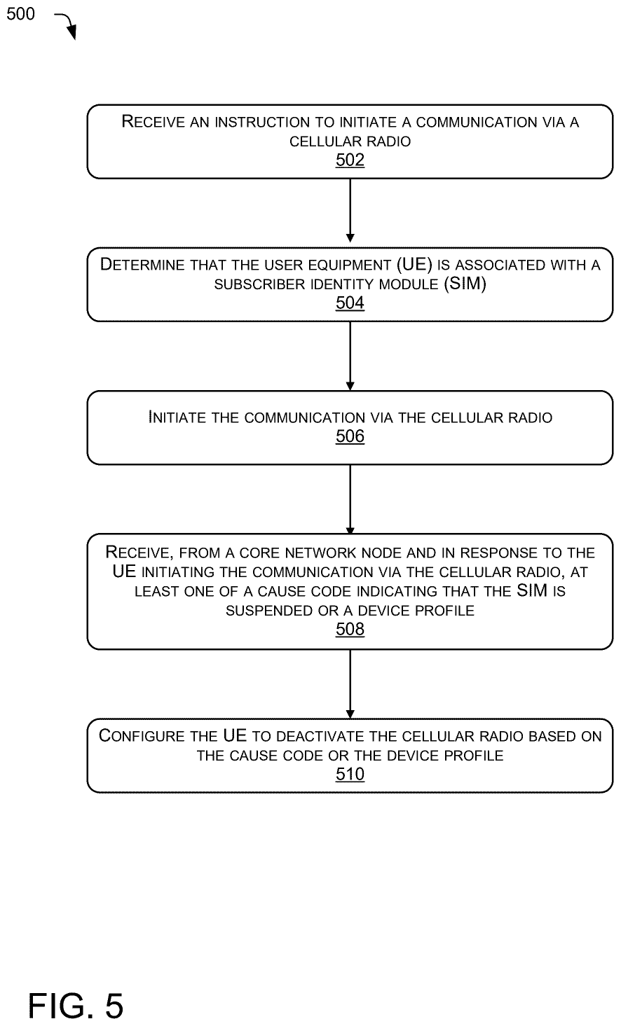

FIGS. 3 and 5 illustrate example processes in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more (non-transitory) computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

At operation 302, the process can include configuring the UE 102 based on a cause code or a device profile. In some examples, the operation 302 can include configuring the UE 102 in accordance with the techniques discussed in FIG. 2, such as in operation 214. In some examples, configuring the UE 102 can include receiving a cause code and accessing a memory accessible by the UE 102 (e.g., within the UE 102 or a memory remote from the UE 102). In some examples, the operation 302 can include accessing a pre-stored device profile based on the cause code. In some examples, the operation 302 can include receiving a device profile from the network (e.g., in the case the device profile is not stored on the UE 102 or the UE 102 does not pull the device profile from the network). The operation 302 can include adjusting a configuration of the UE 102, such as one or more settings, and/or performing one or more actions for the UE 102. In some examples, the operation 302 can include, but is not limited to, one or more of adding a PLMN to a forbidden PLMN list (e.g., in a memory of the UE 102); restricting access by the UE 102 to nodes(s) (e.g., ePDG) (e.g., to disable Wi-Fi calling by the UE 102); deactivating a cellular radio (e.g., to disable a 4G and/or 5G connection); activating Wi-Fi and/or short-range communication (e.g., to provide some functionality to the UE 102); presenting indication(s) (e.g., text, graphics, audio, and the like indicative of or communicating the limited functionality of the UE 102 and/or providing information to a user to activate services associated with the UE 102), and the like.

At operation 304, the process can include disabling cellular radio(s). As mentioned above, in some examples, the cause code and/or the device profile can disable one or more cellular radios on the UE 102, for example, to disable non-emergency communications via 4G, 5G, and/or another cellular communication protocol.

At operation 306, the process can include enabling Wi-Fi and/or short-range communications. In some examples, the operation 306 can be based on receiving a request from a component or application executing on the UE 102, such that this operation may be performed in response to a request for communication from the UE 102. In some examples, short-range communications may include, but are not limited to, Bluetooth, near field communication (NFC), LoRaWAN, and the like. In some examples, the operation 306 can include enabling any non-cellular communication protocols associated with the UE 102.

At operation 308, the process can include allowing non-cellular and non-Wi-Fi call usage. For example, the operation 308 can include allowing data usage by the UE 102 except for non-emergency communication with a base station (e.g., eNodeB or gNodeB) or except for a Wi-Fi call (e.g., Voice over Wi-Fi or a communication path that uses an ePDG as an entry point to a core network).

At operation 310, the process can include determining if a communication request is associated with an emergency call. If yes (e.g., “yes” in operation 310), the process can continue to operation 312.

At operation 312, the process can include enabling cellular radio(s) and initiating communication(s) via the enabled cellular radio(s). In some examples, the operation 312 can include maintaining the cellular radio(s) for at least a predetermined period of time beyond conclusion of an emergency call to facilitate additional communications associated with the UE 102. In some examples, the operation 312 can include enabling location-based services (e.g., GPS or location triangulation) to provide a location estimate of the UE 102 in connection with an emergency call.

If a communication request is not associated with an emergency call (e.g., “no” in operation 310), the process can continue to operation 314.

At operation 314, the process can include determining whether there is an event with a SIM associated with the UE 102. For example, the operation 314 can include determining if a physical SIM is removed from the UE 102 and if the same SIM is replaced in the UE 102 or if a new SIM is coupled to the UE 102. If a SIM is removed and replaced (e.g., “yes” in operation 314) the process continues to operation 316 to enable the cellular radio(s).

At operation 316, the process can include enabling the cellular radios(s) and to facilitate an initial search for network(s) and allowing the UE 102 to attempt to attach to a network. In some examples, the operation 316 can be followed by additional operations discussed herein, such as operation 114 of FIG. 1 or operation 208 of FIG. 2.

If the UE 102 does not detect or determine an event with a SIM (e.g., “no” in operation 314), the process 300 can continue to operation 308 to facilitate non-cellular and non-Wi-Fi call usage.

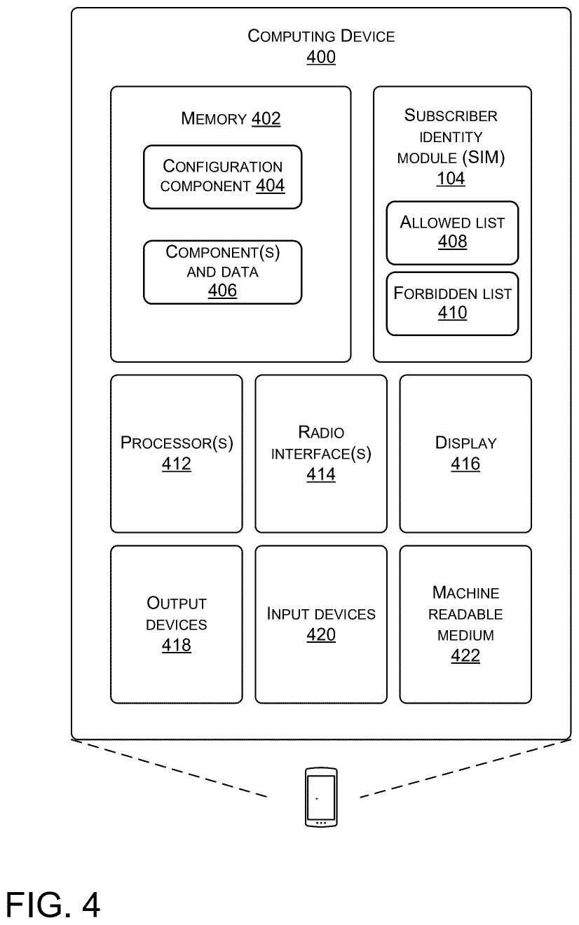

FIG. 4 illustrates an example computing device 400 configured to update a configuration based on the computing device accessing a network with a suspended or deactivated status, in accordance with aspects of the disclosure. In some examples, the computing device 400 can correspond to the UE 102 of FIG. 1. It is to be understood in the context of this disclosure that the computing device 400 can be implemented as a single device, as a plurality of devices, or as a system with components and data distributed among them.

As illustrated, the computing device 400 comprises a memory 402 storing a configuration component 404 and/or component(s) and data 406. Also, the computing device 400 includes the subscriber identity module (SIM) 104 including an allowed list 408 and/or a forbidden list 410. Further, the computing device 400 can include a processor(s) 412, radio interface(s) 414, a display 416, output devices 418, input devices 420, and a machine readable medium 422.

In various implementations, the memory 402 is volatile (such as RAM), non-volatile (such as ROM, flash memory, etc.) or some combination of the two. The configuration component 404 and/or the component(s) and data 406 stored in the memory 402 can comprise (computer-implemented) methods, threads, processes, applications or any other sort of executable instructions. The configuration component 404 and/or the component(s) and data 406 can also include files and databases.

In general, the configuration component 404 can include functionality to receive one or more of a cause code or a device profile, in accordance with the techniques discussed herein. In an example where a cause code is received indicative of a new device configuration or profile, the configuration component 404 can access a database (e.g., internal or remote) to download, install, or otherwise implement a device configuration associated with the cause code. In an example where a device profile is received, the configuration component 404 can install or otherwise implement the device configuration included in the device profile. Example configuration and/or actions associated with a cause code or device profile are discussed throughout this disclosure, but in general, the techniques can include, but are not limited to, one or more of adding a PLMN to a forbidden PLMN list (e.g., in a memory of the UE 102); restricting access by the UE 102 to nodes(s) (e.g., ePDG) (e.g., to disable Wi-Fi calling by the UE 102); deactivating a cellular radio (e.g., to disable a 4G and/or 5G connection); activating Wi-Fi and/or short-range communication (e.g., to provide some functionality to the UE 102); presenting indication(s) (e.g., text, graphics, audio, and the like indicative of or communicating the limited functionality of the UE 102 and/or providing information to a user to activate services associated with the UE 102), and the like.

In some examples, the configuration component 404 can be a special purpose application downloaded and/or installed by the user, and specific to a particular model.

In general, the component(s) and data 406 can be utilized by the computing device 400 to perform or enable performing any action taken by the computing device 400. The components and data 406 can include a UE platform, operating system, and applications, and data utilized by the platform, operating system, and applications.

As noted above, in some examples, the SIM 104 can include the allowed list 408 and the forbidden list 410. In some examples, the allowed list 408 can include identifier(s) associated with one or more networks, such as a PLMN, an HPLM, and eHPLMN, an OPLMN, an EPLMN, and the like. As can be understood in the context of this disclosure, the allowed list 408 can include one or more networks where the computing device 400 is allowed to access the network. In some examples, the forbidden list 410 can include indication(s) of networks where the computing device 400 is not allowed to access. In some examples, PLMN in the allowed list 408 (or the forbidden list 410) can be referred to as an PLMN entry, an HPLM in the allowed list 408 (or the forbidden list 410) can be referred to as an HPLMN entry, and the like.

In some examples, and as can be understood in the context of this disclosure, the configuration component 404 can include functionality to add, remove, or delete entries to and/or from one or more of the allowed list 408 and/or the forbidden list 410. In some examples, entries of the allowed list 408 and/or the forbidden list 410 can be updated upon expiration of one or more times, upon determination that a configuration has been updated or that the computing device 400 is otherwise suspended or disabled, an indication of whether an emergency call is being established, and the like.

In various examples, the processor(s) 412 can be a central processing unit (CPU), a graphics processing unit (GPU), or both CPU and GPU, or any other type of processing unit. Each of the one or more processor(s) 412 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 412 may also be responsible for executing all computer applications stored in the memory 402, which can be associated with common types of volatile (RAM) and/or nonvolatile (ROM) memory.

As noted above, in some examples, the processor(s) 412 can include, but are not limited to, a graphics processing unit (GPU), an Artificial Intelligence (AI) accelerator, a deep learning processor, a neural processing unit (NPU), and the like.

The radio interfaces 414 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 414 can be compatible with multiple radio access technologies, such as 5G radio access technologies and 4G/LTE radio access technologies. Accordingly, the radio interfaces 414 can allow the computing device 400 to connect to various components as described herein. In some examples, the radio interfaces 414 can include a cellular radio component, a short-range wireless communication component, a Wi-Fi component, and the like.

The display 416 can be a liquid crystal display or any other type of display commonly used in computing devices. For example, display 416 may be a touch-sensitive display screen, and can then also act as an input device or keypad, such as for providing a soft-key keyboard, navigation buttons, or any other type of input. The output devices 418 can include any sort of output devices known in the art, such as the display 416, speakers, a vibrating mechanism, and/or a tactile feedback mechanism. Output devices 418 can also include ports for one or more peripheral devices, such as headphones, peripheral speakers, and/or a peripheral display. The input devices 420 can include any sort of input devices known in the art. For example, input devices 420 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 422 can store one or more sets of instructions, such as software or firmware, that embodies any one or more of the methodologies or functions described herein. The instructions can also reside, completely or at least partially, within the memory 402, processor(s) 412, and/or radio interface(s) 414 during execution thereof by the computing device 400. The memory 402 and the processor(s) 412 also can constitute machine readable media 422.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

FIG. 5 illustrates another example process 500 for configuring a user equipment based on a cause code or device profile, in accordance with aspects of the disclosure. The example process 500 can be performed by the UE 102 (and/or another component), in connection with other components and/or devices discussed herein. Some or all of the process 500 can be performed by one or more devices or components in the environment 100, for example.

At operation 502, the process can include receiving an instruction at the user equipment (UE) to initiate a communication via a cellular radio. In some examples, the operation 502 can include the UE 102 receiving an instruction to initiate a communication via an application or via a request from a user, and in some examples, the operation 502 can include an application of the UE 102 determining to route the request via a cellular radio. In some examples, the operation 502 can include similar features as, or can comprise, operations 114 and/or 208.

At operation 504, the process can include determining that the UE is associated with a subscriber identity module (SIM). In some examples, the operation 504 can occur before the operation 502 or the operation 504 can be performed in response to the operation 502. In some examples, the operation 504 can include checking that a SIM is present in the UE (e.g., that a SIM is physically present and/or that the UE is configured with an electronic SIM (eSIM)).

At operation 506, the process can include initiating the communication via the cellular radio by the UE. In some examples, the communication initiated in the operation 506 can include or represent a non-emergency call (e.g., the communication in the operation 506 is not directed to a public safety answering point (PSAP)). In some examples, the operation 506 can include similar features, as, or can comprise, operations 114 and/or 208.

At operation 508, the process can include receiving, at the UE from a core network and in response to the UE initiating a communication via the cellular radio, at least one of a cause code indicating that the SIM is suspended of a device profile. In some examples, the cause code and/or the device profile can be received (in part) from an HSS and/or UDM. In some examples, the operation 508 can include similar features as, or can comprise, operations 116 and/or 212.

At operation 510, the process can include configuring the UE to deactivate the cellular radio based on the cause code or the device profile. In additional or alternative examples, the operation 510 can include, but is not limited to, one or more of adding a PLMN to a forbidden PLMN list (e.g., in a memory of the UE 102); restricting access by the UE 102 to nodes(s) (e.g., ePDG) (e.g., to disable Wi-Fi calling by the UE 102); activating Wi-Fi and/or short-range communication (e.g., to provide some functionality to the UE 102); presenting indication(s) (e.g., text, graphics, audio, and the like indicative of or communicating the limited functionality of the UE 102 and/or providing information to a user to activate services associated with the UE 102), and the like. In various examples, the operation 510 may be performed by a configuration component of the UE based on the cause code or the device profile.

Accordingly the techniques discussed herein describe configuring a user equipment (e.g., for limited functionality) that has been suspended or deactivated.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed IS:

1. A user equipment comprising:
one or more processors; and
one or more non-transitory computer readable media storing computer executable instructions that, when executed, cause the one or more processors to perform operations comprising:
receiving an instruction to initiate a communication via a cellular radio;
determining that the user equipment (UE) is associated with a subscriber identity module (SIM);
initiating the communication via the cellular radio;
receiving, from a core network node and in response to the UE initiating the communication via the cellular radio, at least one of a cause code indicating that the SIM is suspended or a device profile; and
configuring the UE to deactivate the cellular radio based on the cause code or the device profile.

2. The user equipment of claim 1, wherein receiving the at least one of the cause code or the device profile comprises receiving the cause code, the operations further comprising:
activating a device profile pre-stored on the UE in response to receiving the cause code.

3. The user equipment of claim 1, wherein receiving the at least one of the cause code or the device profile comprises receiving the device profile, and wherein the device profile is indicative of the UE being suspended, the operations further comprising:
configuring the UE based on the device profile.

4. The user equipment of claim 1, wherein configuring the UE based on the cause code or the device profile comprises removing one or more Home Public Land Mobile Network (HPLMN) entry, Equivalent Home PLMN (eHPLMN) entry, or Operator PLMN (OPLMN) entry from the UE or the SIM.

5. The user equipment of claim 1, wherein configuring the UE further comprises enabling at least one of a Wi-Fi radio component or a short-range wireless communication component based on the cause code or the device profile.

6. The user equipment of claim 1, wherein after configuring the UE to deactivate the cellular radio based on the cause code or the device profile, the cellular radio remains deactivated until at least one of the SIM is reactivated, the UE is controlled to dial an emergency number, or the SIM is replaced with a different SIM.

7. The user equipment of claim 1, the operations further comprising:
presenting an indication on a display of the UE indicating that the cellular radio is disabled.

8. The user equipment of claim 1, the operations further comprising:
configuring the UE to prevent the UE from accessing an Evolved Packet Data Gateway (ePDG) in a core network associated with the core network node.

9. A computer-implemented method comprising:
receiving, at a user equipment (UE), an instruction to initiate a communication via a cellular radio;
determining that the UE is associated with a subscriber identity module (SIM);
initiating the communication via the cellular radio;
receiving, from a core network node and in response to the UE initiating the communication via the cellular radio, at least one of a cause code indicating that the SIM is suspended or a device profile; and
configuring the UE to deactivate the cellular radio based on the cause code or the device profile.

10. The computer-implemented method of claim 9, wherein receiving the at least one of the cause code or the device profile comprises receiving the cause code, the computer-implemented method further comprising:
activating a device profile pre-stored on the UE in response to receiving the cause code.

11. The computer-implemented method of claim 9, wherein receiving the at least one of the cause code or the device profile comprises receiving the device profile, and wherein the device profile is indicative of the UE being suspended, the computer-implemented method further comprising:
configuring the UE based on the device profile.

12. The computer-implemented method of claim 9, wherein configuring the UE based on the cause code or the device profile comprises removing one or more Home Public Land Mobile Network (HPLMN) entry, Equivalent Home PLMN (eHPLMN) entry, or Operator PLMN (OPLMN) entry from the UE or the SIM.

13. The computer-implemented method of claim 9, wherein configuring the UE further comprises enabling at least one of a Wi-Fi radio component or a short-range wireless communication component based on the cause code or the device profile.

14. The computer-implemented method of claim 9, wherein after configuring the UE to deactivate the cellular radio based on the cause code or the device profile, the cellular radio remains deactivated until at least one of the SIM is reactivated, the UE is controlled to dial an emergency number, or the SIM is replaced with a different SIM.

15. The computer-implemented method of claim 9, further comprising:
presenting an indication on a display of the UE indicating that the cellular radio is disabled.

16. The computer-implemented method of claim 9, further comprising:
configuring the UE to prevent the UE from accessing an Evolved Packet Data Gateway (ePDG) in a core network associated with the core network node.

17. One or more non-transitory computer-readable media storing computer executable instructions that, when executed, cause one or more processors to perform operations comprising:
receiving, at a base station of a network, one or more messages from a user equipment (UE) to at least one of attach to the base station or initiate communication with the network;
determining, by a network node of the network, that a Subscriber Identity Module (SIM) of the UE is suspended or deactivated; and
in response to determining that the SIM of the UE is suspended or deactivated, sending, by the network node of the network, at least one of a cause code indicating that the SIM is suspended or a device profile to the UE to cause the UE to deactivate a cellular radio of the UE based on the cause code of the device profile.

18. The one or more non-transitory computer-readable media of claim 17, wherein the base station is configured to communicate via at least one of 4G protocols or 5G protocols, and wherein the one or more messages are received from a cellular radio of the UE.

19. The one or more non-transitory computer-readable media of claim 17, wherein the cause code or the device profile configures the UE by removing one or more Home Public Land Mobile Network (HPLMN) entry, Equivalent Home PLMN (eHPLMN) entry, or Operator PLMN (OPLMN) entry from the UE or the SIM.

20. The one or more non-transitory computer-readable media of claim 17, wherein the cause code or the device profile configures the UE by enabling at least one of a Wi-Fi radio component or a short-range wireless communication component based on the cause code or the device profile.
